(19) United States
(12) Patent Application Publication
(10) Pub. No.: US 2012/0069615 A1
(43) Pub. Date: Mar. 22, 2012

(54) BRIDGELESS POWER FACTOR CORRECTION CONVERTER

(75) Inventor: Satoshi TOMIOKA, Tokyo (JP)

(73) Assignee: TDK CORPORATION, TOKYO (JP)

(21) Appl. No.: 13/227,163

(22) Filed: Sep. 7, 2011

(30) Foreign Application Priority Data
Sep. 21, 2010 (JP) 2010-211203

(51) Int. Cl. H02M 7/06

(52) U.S. Cl. 363/126

(57) ABSTRACT

A bridgeless power factor correction converter is configured such that a gate driver controls the ON ratio of a booster converter switch so that the ON ratio is gradually increased from 0, i.e., performs soft start control, every time the voltage polarity of an AC input in a totem-pole bridgeless power factor converter (TPBL converter is inverted) is inverted.

### CROSS-REFERENCE TO RELATED APPLICATIONS

This application is based upon and claims the benefit of priority from Japanese Patent Application No. 2010-211203, filed on Sep. 21, 2010, the entire contents of which are incorporated herein by reference.

### BACKGROUND OF THE INVENTION

1. Field of the Invention

The present invention relates to a bridgeless power factor correction converter that has no bridge circuit to rectify an alternating current input.

2. Description of the Related Art

Conventionally, a switching power supply that is connected to an alternating current (AC) input uses a power factor correction converter in order to correct the power factor of the input current and inhibit the harmonic current. Normal power factor correction converters usually use a boost converter to control power factor correction after using a diode bridge to rectify an AC voltage to a positive DC voltage.

However, it is known that, when a rectifying bridge is provided as described above, the loss in the bridge inhibits an increase in the efficiency of the power factor correction converter and its size reduction. Accordingly, various bridgeless power factor correction converters that include no bridge have been proposed (see Japanese National Publication of International Patent Application No. 2007-527687).

One type of bridgeless power factor converter that has been proposed is a totem-pole bridgeless power factor converter (hereinafter, “TPBL converter”), in which a switching device that is switched at a high frequency during a positive half cycle of an AC input and a switching device that is switched at a high frequency during a negative half cycle of an AC input are connected to an inductor that is provided on the AC input side.

The above-described TPBL converter, however, has a problem in that an excessive surge current flows into the inductor at the zero cross point of the input voltage and accordingly a surge occurs in the input current and the input voltage. The surge current and the surge voltage increase the noise of the converter, i.e., an electromagnetic interface (EMI) noise, which reduces the efficiency.

Accordingly, a significant objective is achieving a bridgeless power factor correction converter that can achieve noise reduction and efficiency improvement by preventing a surge near the zero cross point of the input voltage. This objective is not limited to TPBL converters and may be an objective for other bridgeless power factor correction converters.

### SUMMARY OF THE INVENTION

A bridgeless power factor correction converter according to an aspect of the present invention has no bridge rectifier circuit that rectifies an alternating current input from an alternating current power supply, and includes a switching device for a booster converter; and a gate driver that gradually increases an ON ratio of the switching device every time a voltage polarity of the alternating current input is inverted.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram of an overview of a gate driving method according to an embodiment of the present invention;

FIG. 2 is a diagram of a circuit configuration of a bridgeless power factor correction converter according to a first embodiment;

FIG. 3 is a block diagram of a configuration example of a gate driver;

FIGS. 4A to 4C illustrate a positive half-wave operation;

FIGS. 5A to 5C illustrate a negative half-wave operation;

FIG. 6 is a diagram of the operation waveform of each unit when the gate driver performs soft start control;

FIGS. 7A to 7C illustrate a specific example of the soft start control;

FIG. 8 is a diagram of the operation waveform of each unit when the soft start control is not performed;

FIGS. 9A and 9B illustrate the occurrence of a surge when the soft start control is not performed;

FIGS. 10A and 10B illustrate a first pattern of the operation waveforms when the soft start control is performed and the operation waveforms when the soft start control is not performed;

FIGS. 11A and 11B illustrate a second pattern of the operation waveforms when the soft start control is performed and the operation waveforms when the soft start control is not performed;

FIG. 12 is a diagram of detailed operation waveforms when the soft start control is performed; and

FIG. 13 is a diagram of a circuit configuration of a bridgeless power factor correction converter according to a second embodiment.

### DETAILED DESCRIPTION OF THE PREFERRED EMBODIMENTS

A bridgeless power factor correction converter according to embodiments of the present invention will be described with reference to the accompanying drawings. In the embodiments described below, a circuit that includes switching devices whose gates are to be driven is illustrated. However, this illustration does not limit the present invention.

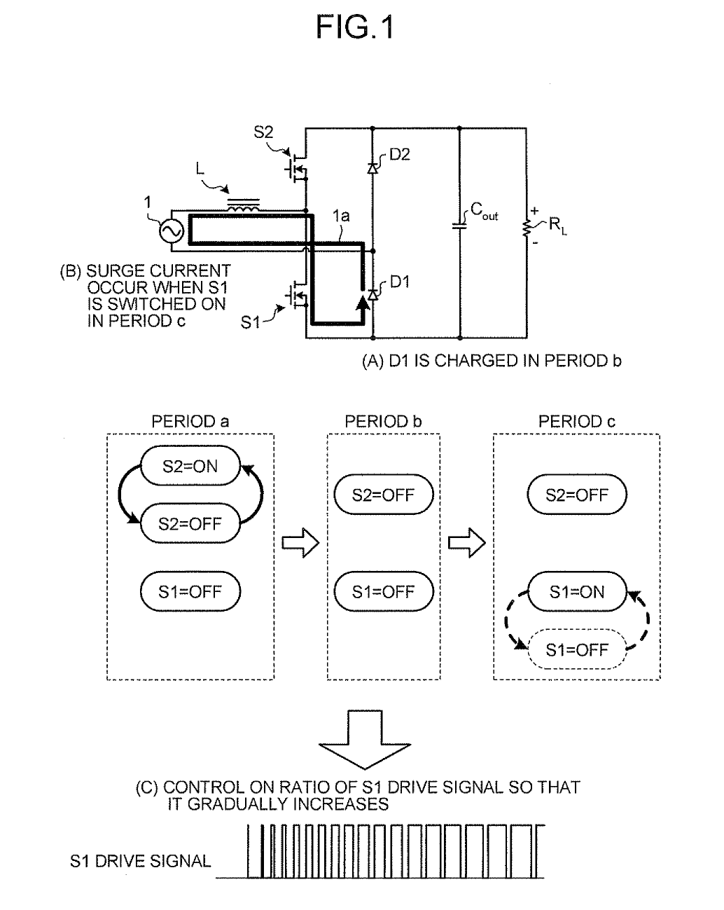

An overview of a gate driving method according to an embodiment of the present invention will be described using FIG. 1 and then, in a first embodiment, a bridgeless power factor correction converter to which the gate driving method is applied will be described and, in a second embodiment, an interleaved bridgeless power factor correction converter in which two booster converters are arranged in parallel will be described.

First, an overview of the gate driving method according to an embodiment of the present invention will be described using FIG. 1. FIG. 1 is a diagram of the overview of the gate driving method according to the embodiment of the present invention. The circuit shown in FIG. 1 is a totem-pole bridgeless power factor converter (TPBL converter).

The “totem-pole” is so named because multiple switching devices appear as vertical stacks in circuit diagrams. The switching devices of the TPBL converter are connected to an AC input power supply via an inductor, which leads to an advantage in that the effect of the switching noise is absorbed by the inductor and thus is not easily transferred to the side of the AC input power supply.

As shown in FIG. 1, the TPBL converter includes an inductor L, a switching device S1, a switching device S2, a diode D1, a diode D2, and a capacitor Cₒᵤₜ.

Assuming that the positive side of an AC input power supply 1 is the upper side in FIG. 1 (hereinafter, descriptions will be given similarly providing that the positive side of the AC input power supply 1 is the upper side in each drawing), the switching device S1 is switched at a high frequency during a positive half cycle of an AC current and the switching device S2 is switched at a high frequency during a negative half cycle.

For example, as shown in FIG. 1, in a negative half cycle (see “Period a” in FIG. 1), while the switching device S2 is controlled so as to be repeatedly switched ON and OFF at a high frequency, the switching device S1 is controlled so as to be kept OFF.

In the dead time of a predetermined period (see “Period b” in FIG. 1), the switching device S1 and the switching device S2 are both controlled so as to be OFF. The dead time is provided as described above because, if both of the switching device S1 and the switching device 52 are turned ON simultaneously due to a delay in the switching operation or the effect of noise, the output voltage damages the switching devices.

In a positive half cycle (see “Period c” in FIG. 1) after Period b, while the switching device S1 is controlled so as to be switched ON and OFF repeatedly at a high frequency, the switching device S2 is controlled so as to be kept OFF.

At the point at which the input voltage of the AC input power supply 1 is switched from a negative voltage to a positive voltage or from a positive voltage to a negative voltage (hereinafter, “zero cross point”), the input voltage of the AC input power supply 1 is 0; therefore, the voltage across both terminals of the parasitic capacitor of the switching device S2 and the parasitic capacitor of the diode D2 is 0.

Accordingly, the output voltage is applied to the parasitic capacitor of the switching device S1 and the parasitic capacitor of the diode D1 and thus each of the parasitic capacitors is charged (see (A) of FIG. 1).

In Period c, i.e., in the positive half cycle, when the switching device S1 is turned ON first, the parasitic capacitor of the diode D1 is discharged and a surge current flows to the side of the AC input power supply 1 along a path 1a in FIG. 1 (see (B) of FIG. 1). The charge stored in the parasitic capacitor of the switching device S1 circulates in the device and disappears when the switching device S1 is turned ON.

A similar phenomenon occurs in the negative half cycle, when the switching device S2 is turned ON first, because the parasitic capacitor of the diode D2 is discharged.

In other words, the TPBL converter in FIG. 1 has a problem in that the surge current flows to the side of the AC input power supply 1 immediately after the zero cross point of the input voltage and accordingly a noise occurs. Furthermore, the TPBL also has a problem in that, once a surge current flows, resonance occurs in the resonant circuit consisting of the inductor L and the parasitic capacitor of the diode D1 (or the diode D2) and the adverse effect due to the surge current continues.

In the gate driving method according to the embodiment of the present invention, the ON ratio of a drive signal that drives the gate of each switching device is controlled so as to gradually increase from 0% immediately after the zero cross point, i.e., soft start control is performed (see (C) of FIG. 1).

Immediately after the zero cross point of the AC input at which a negative voltage is switched to a positive voltage, the soft start control is performed on the switching device S1. Immediately after the zero cross point at which a positive voltage is switched to a negative voltage, the soft start control is performed on the switching device S2.

By performing the soft start control, a surge current can be prevented from occurring immediately after the zero cross point of the input voltage. This is because, by releasing charge stored in the parasitic capacitor of the diode D1 (or the diode D2), the cause of the phenomenon, which is that the charge is released all at once, i.e., a surge current, can be eliminated.

Because performing soft start control too often may deteriorate the power factor correction performance, the gate driving method according to the embodiment of the present invention appropriately defines the period and details of the soft start control, thereby improving the efficiency of the power factor correction converter. The details will be described below.

By using the gate driving method according to the embodiment of the present invention, a bridgeless power factor correction converter that achieves both noise reduction and efficiency improvement can be configured. Descriptions will be given below for bridgeless power factor correction converters according to the first embodiment to which the gate driving method, which is described using FIG. 1, is applied.

### First Embodiment

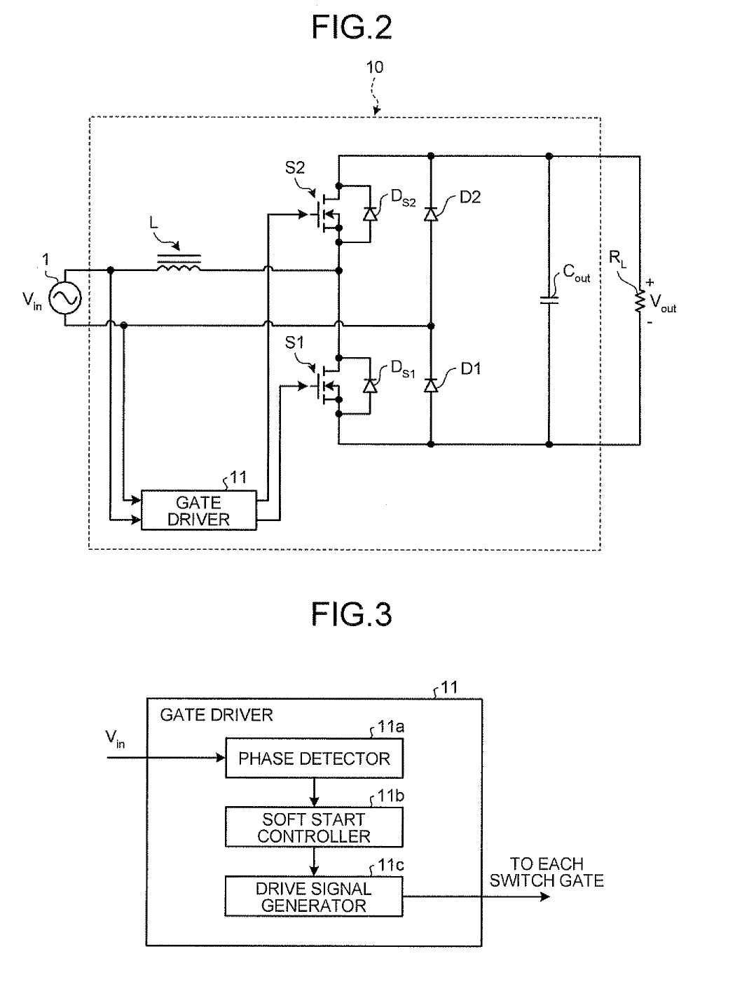

FIG. 2 is a diagram of a circuit configuration of a bridgeless power factor correction converter 10 according to the first embodiment. As shown in FIG. 2, the bridgeless power factor correction converter 10 boosts an input voltage Vᵢₙ and produces a direct current (DC) output voltage Vₒᵤₜ with a load resistance R_{L}.

As shown in FIG. 2, the bridgeless power factor correction converter 10 includes the booster inductor L, the switching device S1, the switching device S2, the diode D1 and the diode D2, which are one-direction devices, the capacitor Cₒᵤₜ, and a gate driver 11 that drives the gate of each switching device.

A normal booster converter is configured by connecting one terminal of a booster inductor to the positive side of an input power supply and connecting the other terminal of the booster inductor to the switching devices and the anode of an output diode. In the bridgeless power factor correction converter 10 shown in FIG. 2, every time the voltage polarity of the AC input power supply 1 is inverted, the switching device functioning as a switch is switched and the diode functioning as an output diode is switched.

In other words, when the voltage polarity on the positive side (upper side in FIG. 1) of the AC input power supply 1 is positive, the switching device S1 functions as a switch and the diode D2 connected in parallel with the switching device S2 functions as the output diode. In contrast, when the voltage polarity on the positive side (upper side in FIG. 1) of the AC input power supply 1 is negative, the switching device S2 functions as a switch and the diode D1 connected in parallel to the switching device S1 functions as the output diode.

FIG. 2 illustrates a case in which the switching device S1 and the switching device S2 are metal-oxide-semiconductor field-effect transistors (MOSFETs) and the switching devices each include a body diode.

Thus, FIG. 2 shows a body diode D_{S1} of the switching device S1 and a body diode D_{S2} of the switching device S2. The directions of the body diode Dₛ₁ and the body diode Dₛ₂ lead from the source of each switching device to the drain. As described above, the body diodes of the respective switching devices alternately function as the output diode.

As shown in FIG. 2, one terminal of the booster inductor L is connected to the positive side of the AC input power supply 1 and the drain of the switching device S1 and the source of the switching device S2 are connected to the other terminal of the inductor L. The diode D1 is connected in parallel to the switching device S1 and the diode D12 is connected in parallel to the switching device S2.

Specifically, the anode of the diode D1 is connected to the source of the switching device S1 and the cathode of the diode D1 is connected to the negative side of the AC input power supply 1. In addition, the cathode of the diode D2 is connected to the drain of the switching device S2 and the anode of the diode D2 is connected to the negative side of the AC input power supply 1.

The capacitor Cₒᵤₜ is provided in parallel with the load resistor R_{L} after the diode D1 and the diode D2. The gate driver 11 is connected to the positive and negative sides of the AC input power supply 1 and outputs gate drive signals to the gates. These gate drive signals drive the gate of the switching device S1 and the gate of the switching device S2.

The bridgeless power factor correction converter 10 according to the first embodiment is characterized in that, immediately after the zero cross point of the input voltage of the AC input power supply 1, the soft start control is performed on a gate drive signal that drives the gate of a switching device.

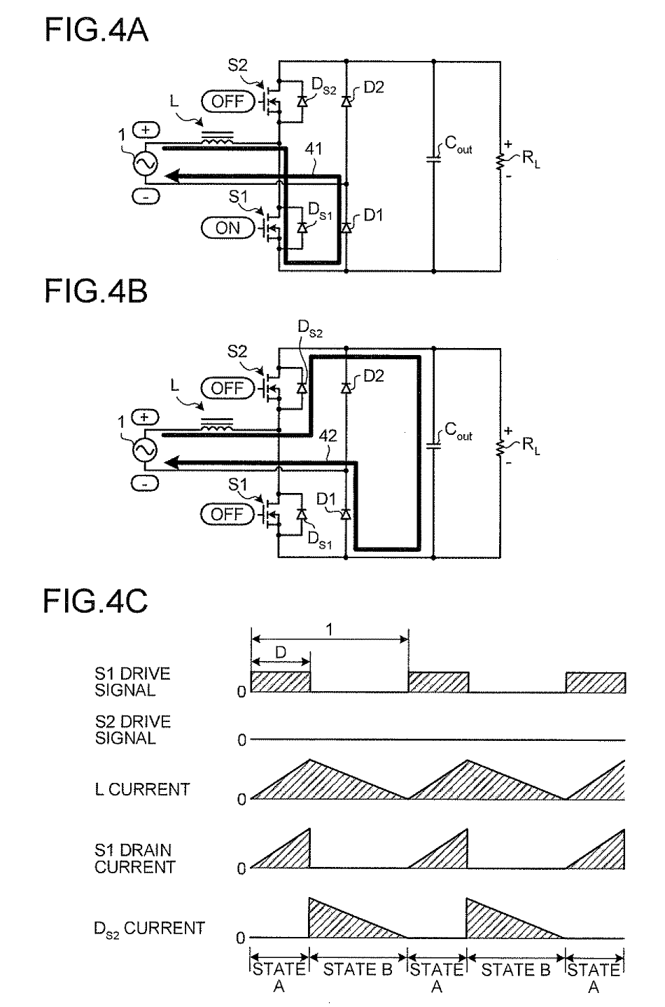

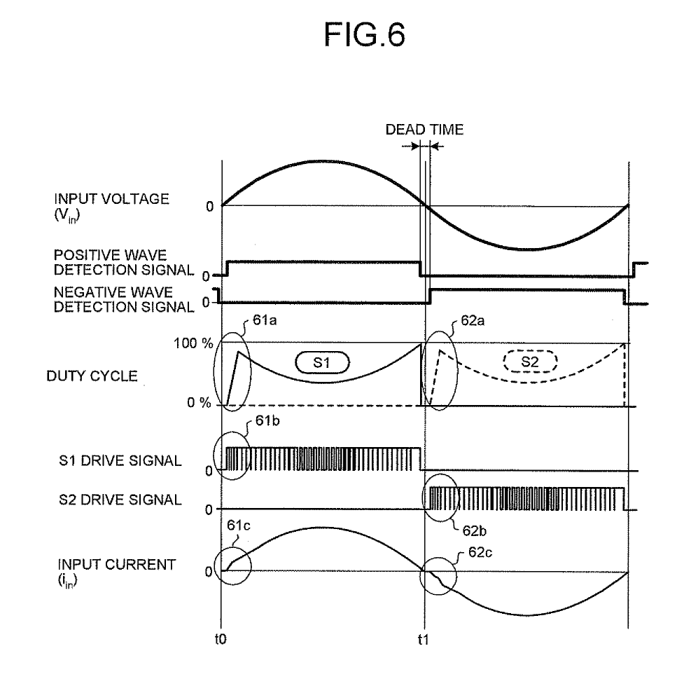

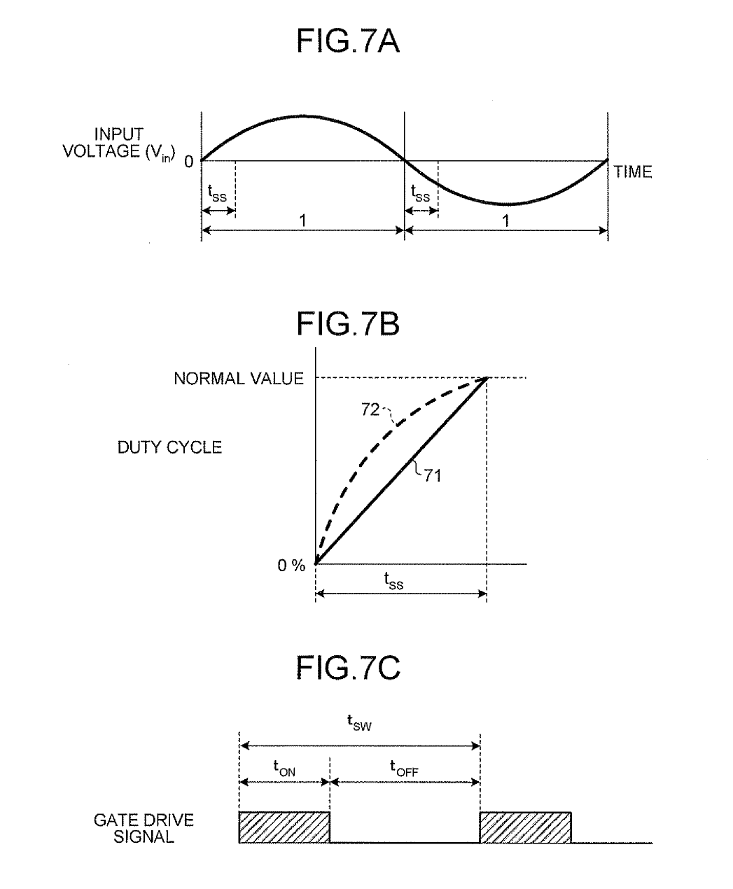

Details of the soft start control will be described below using FIGS. 6 and 7. The operations of the bridgeless power factor correction converter 10 in FIG. 2 will be described below using FIG. 4.

A configuration example of the gate driver 11 shown in FIG. 2 will be described using FIG. 3. FIG. 3 is a block diagram of the gate driver 11. As shown in FIG. 3, the gate driver 11 includes a phase detector 11a that detects a phase of an input voltage (Vᵢₙ), a soft start controller 11b that performs the above-described soft start control, and a drive signal generator 11c that generates drive signals that respectively drive the gate of each switching device.

The phase detector 11a monitors the state of the input voltage (Vᵢₙ) and performs a process of detecting the zero cross point at which the voltage polarity is switched from negative to positive. Specifically, the phase detector 11a generates a positive wave detection signal that is logically high during a period in which the input voltage (Vᵢₙ) is in a positive phase and is logically zero during other periods and generates a negative wave detection signal that is logically high during a period in which the input voltage (Vᵢₙ) is in a negative phase and is logically zero during other periods.

Here, the positive wave detection signal and the negative wave detection signal are adjusted so as not to have any period in which the input voltage (Vᵢₙ) is logically high. In other words, the phase detector 11a adds an appropriate dead time before and after the zero cross point. The phase detector 11a also performs a process of passing the generated positive wave detection signal and the negative wave detection signal to the soft start controller 11b.

Upon detecting a rising edge of the positive wave detection signal, or a rising edge of the negative wave detection signal, which is passed from the phase detector 11a, the soft start controller 11b performs a process of adjusting the ON ratio of the switching device (the switching device S1 or the switching device S2) whose gate is driven so as to gradually increase the ON ratio from 0%, i.e., performs the soft start control.

The drive signal generator 11c performs a process of generating, on the basis of the ON ratio adjusted by the soft start controller 11b, a pulse width modulation (PWM) signal that drives the gate of each switching device and of outputting the generated PWM signal.

Each unit illustrated in FIG. 3 may be configured as a circuit or may be configured as a microcomputer or as a program that is executed on the microcomputer.

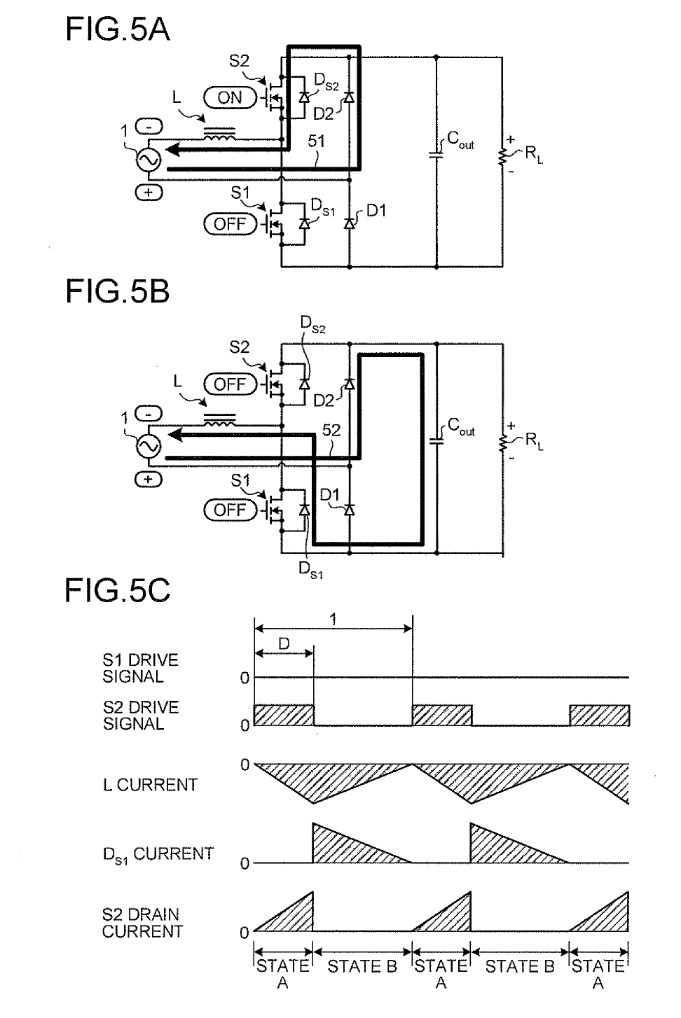

Basic operations of the bridgeless power factor correction converter 10 in FIG. 2 will be described using FIGS. 4A to 4C and 5A to 5C. FIGS. 4A to 4C illustrate a positive half-wave operation and FIGS. 5A to 5C illustrate a negative half-wave operation. Hereinafter, the direction leading from the anode to the cathode in the diodes is referred to as the positive direction and the direction leading from the drain to the source in the switching devices is referred to as the positive direction. Regarding other components (for example the inductor L), the positive side of the AC input is referred to as positive.

The positive half-wave operation of the bridgeless power factor correction converter 10 will be described using FIGS. 4A to 4C. As shown in FIG. 4A, if the voltage polarity of the positive side (upper side in the circuit diagram) of the AC input power supply 1 is positive, the gate driver 11 controls the switching device S2 so as to be kept OFF while controlling the switching device S1 so as to be repeatedly switched ON and OFF at a high frequency.

As shown in FIG. 4A, when the switching device S1 is turned ON, the input current flows along a path 41 back to the AC input power supply 1 via the inductor L, the switching device S1, and the diode D1.

As shown in FIG. 4B, when the switching device S1 is turned OFF, the input current flows along a path 42 back to the AC input power supply 1 via the inductor L, the body diode Dₛ₂ of the switching device S2, the capacitor Cₒᵤₜ, and the diode D1.

The waveform of the main portion in the positive half-wave operation is like that in FIG. 4C. “State A” and “State B” in FIG. 4C correspond to the state in FIG. 4A and the state in FIG. 4B, respectively.

Specifically, the ON ratio of the gate drive signal (S1 drive signal) of the switching device S1 corresponds to repetition of “D” of the PWM signal. In contrast, the gate drive signal (S2 drive signal) to the switching device S2 is kept at 0. The ON ratio (D) is adjusted by the soft start controller lib of the gate driver 11, which will be described below using FIGS. 6 and 7A to 7C.

As shown in FIG. 4C, an L current that flows into the inductor L increases linearly from 0 in State A and decreases linearly in State B. An S1 drain current that flows into the drain of the switching device S1 linearly increases from 0 in State A and is kept at 0 in State B. A D_{S2} current that flows into the body diode Dₛ₂ of the switching device S2 is kept at 0 in State A and linearly decreases from the maximum value in State B.

The negative half-wave operation of the bridgeless power factor correction converter 10 will be described using FIGS. 5A to 5C. As shown in FIG. 5A, if the voltage polarity of the positive side (upper side in the circuit diagram) of the AC input power supply 1 is negative, the gate driver 11 controls the switching device S1 so as to be kept OFF while controlling the switching device S2 so as to be repeatedly switched ON and OFF at a high frequency.

As shown in FIG. 5A, when the switching device S2 is turned ON, the input current flows along a path 51 back to the AC input power supply 1 via the diode D2, the switching device S2, and the inductor L.

As shown in FIG. 5B, when the switching device S2 is turned OFF, the input current flows along a path 52 back to the AC input power supply 1 via the diode D2, the capacitor Cₒᵤₜ, the body diode D_{S1} of the switching device S1, and the inductor L.

The waveform of the main portion in the negative half-wave operation is like that in FIG. 5C. “State A” and “State B” in FIG. 5C correspond to the state in FIG. 5A and the state in FIG. 5B, respectively.

Specifically, the ON ratio of the gate drive signal (S2 drive signal) of the switching device S2 corresponds to repetition of “D” of the PWM signal. In contrast, the gate drive signal (S1 drive signal) to the switching device S1 is kept at 0. The ON ratio (D) is adjusted by the soft start controller lib of the gate driver 11, which is the same as those in FIGS. 4A and 4B.

As shown in FIG. 5C, the L current that flows into the inductor L decreases linearly from 0 in State A and increases linearly in State B. A D_{S1} current that flows into the body diode D_{S1} of the switching device S1 is kept at 0 in State A and decreases linearly from the maximum value in State B. An S2 drain current that flows into the drain of the switching device S2 increases linearly in State A and is kept at 0 in State B.

The details of the soft start control that is performed by the soft start controller 11b of the gate driver 11 will be described using FIGS. 6 and 7A to 7C. FIG. 6 is a diagram of the operation waveform of each unit when the gate driver 11 performs the soft start control and FIGS. 7A to 7C illustrate a specific example of the soft start control.

As shown in FIG. 6, the soft start controller 11b controls the ON ratio (D) so that it gradually increases from 0 at the start of a duty cycle (see 61a and 62a in FIG. 6). Accordingly, each pulse width of the PWM signal generated by the drive signal generator 11c is adjusted so that it gradually increases at the start of the duty cycle (see 61b and 62b of FIG. 6).

As shown in FIG. 6, the soft start control inhibits the surge in the input current (iᵢₙ) immediately after the zero cross point (see 61c and 62c in FIG. 6).

The DC output voltage (Vₒᵤₜ) can be represented using the ON ratio (D) and the AC input voltage (Vᵢₙ) by the following Equation (1).

$${V}_{out} = \frac{1}{1 - D} {V}_{i n} \qquad ( 1 )$$

In order to keep the output voltage (Vₒᵤₜ) constant, the ON ratio (D) needs to be close to 1 as much as possible when the input voltage (Vᵢₙ) is 0.

The input voltage (Vᵢₙ) is an AC input and thus is represented by the following Equation (2), where V_{AC} is a predetermined constant, ω is angular frequency, and t is time.

Vᵢₙ=V_{AC} sin(ωt) (2)

According to Equation (1) and Equation (2), the ON ratio (D) is represented by the following Equation (3).

$$D = 1 - \frac{{V}_{i n}}{{V}_{out}} = 1 - \vert \frac{{V}_{ A C} sin ( ω t )}{{V}_{out}} \vert \qquad ( 3 )$$

As is clear from Equation (3), it is preferable that the ON ratio (D) be 1 in order to keep Vᵢₙ 0, i.e., keep the output voltage (Vₒᵤₜₜ) constant at the zero cross point. However, when the ON ratio (D) is 1, the above-described problem of surge current is caused; therefore, the soft start control to gradually increase the ON ratio (D) from 0 is performed as shown in FIG. 6. The ON ratio (D) is adjusted so that it is approximately inverse to changes in Vᵢₙ in time.

FIG. 6 represents the zero cross point t0 at which the polarity of the input voltage (Vᵢₙ) is switched from negative to positive and the zero cross point t1 at which the polarity of the input voltage (Vᵢₙ) is switched from positive to negative.

A specific example of the soft start control performed by the soft start controller lib will be described using FIGS. 7A to 7C. As shown in FIG. 7A, the soft start controller lib sets, as a soft start target period, the start of a half wave of the input voltage (Vᵢₙ) (between the zero cross points), i.e., t_{SS} shown in FIG. 7A.

Here, t_{SS} represents the ratio, providing that the half wave period is 1, and is preferably 5% to 10%. If t_{SS} is too large (for example, 20%), it is not preferable because deterioration of the power factor correction performance is a concern. Because an appropriate value of t_{SS} varies depending on the circuit configuration, it is preferable to determine the occurrence of the surge current by a test or a simulation and to adjust t_{SS} such that the surge current is within an allowable range.

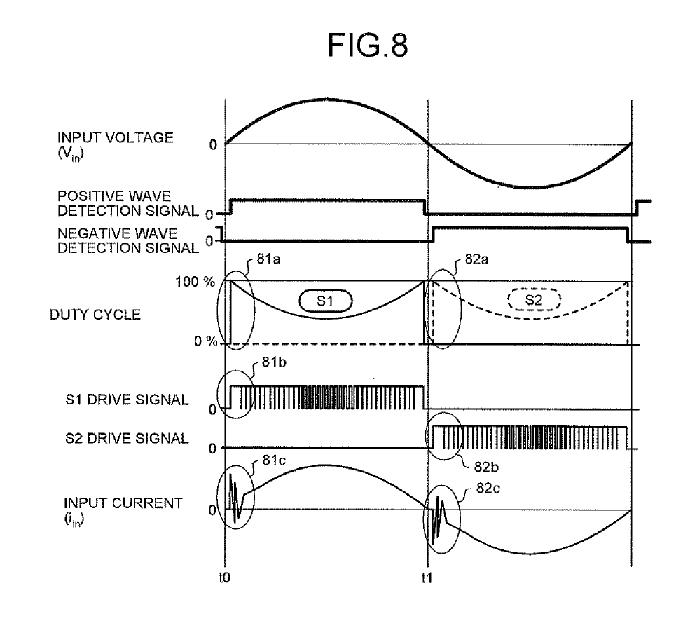

As shown in FIG. 7B, the soft start controller 11b controls the ON ratio (D) so as to be linearly increased from 0% to a normal value in the t_{SS} period (see 71 in FIG. 7B). Instead of linearly increasing the ON ratio (D), the ON ratio (D) may be increased such that the variation ratio gradually decreases so as to smoothly approach the normal value (see 72 in FIG. 7B). The normal value is the ON ratio (D) at the end of the t_{SS} period in the duty cycle (see FIG. 8 described below) when the soft start control is not performed.

As shown in FIG. 7C, providing that the period of the PWM signal is t_{SW}, the period in which the signal is ON is t_{ON}, and the period in which the signal is OFF is t_{OFF}, the sum of t_{ON} and t_{OFF} is t_{SW}. The above-described ON ratio (D) can be represented as a value obtained by dividing t_{ON} by the sum (t_{SW}) of t_{ON} and t_{OFF}.

The soft start controller 11b adjusts the ON ratio (D) by changing t_{ON}, with t_{SW} being a fixed period. Alternatively, the ON ratio (D) may be adjusted by changing t_{OFF} or t_{SW}, with t_{ON} being fixed.

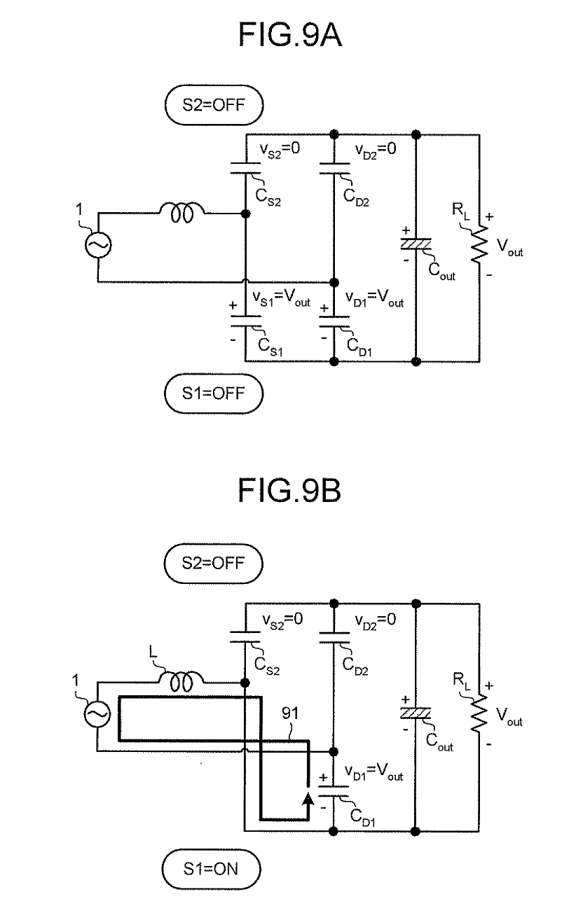

To clarify the effect of the soft start control, the operation of each unit and the operation leading to the occurrence of a surge when the soft start control is not performed will be described using FIG. 8 and FIG. 9. FIG. 8 is a diagram of the operation waveform of each unit when the soft start control is not performed and FIG. 9 contains diagrams illustrating occurrence of a surge when the soft start control is not performed.

As shown in FIG. 8, when the soft start control is not performed, the ON ratio is controlled so as to be 100% in accordance with turning on of the positive wave detection signal (see 81a and 82a in FIG. 8). Accordingly, each pulse of the PWM signal that drives the gate of each switching device becomes continuous (see 81a and 82a in FIG. 8).

In other words, when the soft start control is not performed, the phenomenon that the charge stored in the parasitic capacitor of the diode D1 or the diode D2 flows all at once into the AC input power supply 1 occurs and resonance occurs in the resonant circuit consisting of the inductor L and the parasitic capacitor of each diode. Accordingly, a surge current occurs in the input current (iᵢₙ) and this effect continues (see 81c and 82c in FIG. 8).

FIG. 8 shows the zero cross point t0 at which the polarity of the input voltage (Vᵢₙ) switches from negative to positive and the zero cross point t1 at which the polarity of the input voltage (Vᵢₙ) switches from positive to negative.

The operation leading to occurrence of a surge will be described using FIGS. 9A and 9B. FIGS. 9A and 9B illustrate an equivalent circuit at the zero cross point in FIG. 8, i.e., at the point in which the polarity of the input voltage (Vᵢₙ) switches from negative to positive.

Specifically, as shown in FIG. 9A, at the zero cross point t0, both the switching device S1 and the switching device S2 are OFF and the input voltage (Vᵢₙ) is 0; therefore, a voltage V_{S2} applied to a parasitic capacitor C_{S2} of the switching device S2 and a voltage V_{D2} applied to a parasitic capacitor C_{D2} of the diode D2 are both 0.

Accordingly, a voltage V_{S1} applied to a parasitic capacitor C_{S1} of the switching device S1 and a voltage V_{D1} applied to a parasitic capacitor C_{D1} of the diode D1 are equivalent to the output voltage Vₒᵤₜ. Thus, charge is stored in the parasitic capacitor C_{S1} and the parasitic capacitor C_{D1} (the capacitors are charged).

As shown in FIG. 9B, when the switching device S1 is turned on, the charge stored in the parasitic capacitor C_{D1} of the diode D1 is released and thus a surge current flows along a path 91 back to the parasitic capacitor C_{D1} via the AC input power supply 1 and the inductor L.

If the soft start control is not performed, as indicated by 81b and 82b in FIG. 8, the state where the switching devices is continuously switched ON continues immediately after the zero cross point; therefore, the charge stored in the parasitic capacitor C_{D1} is released all at once. Accordingly, the surge current in accordance with the charge release becomes excessive.

In order to prevent such a surge current, the soft start controller 11b performs the soft start control in order to gradually increase, from 0, the ON ratio (D) of the switching device immediately after the zero cross point.

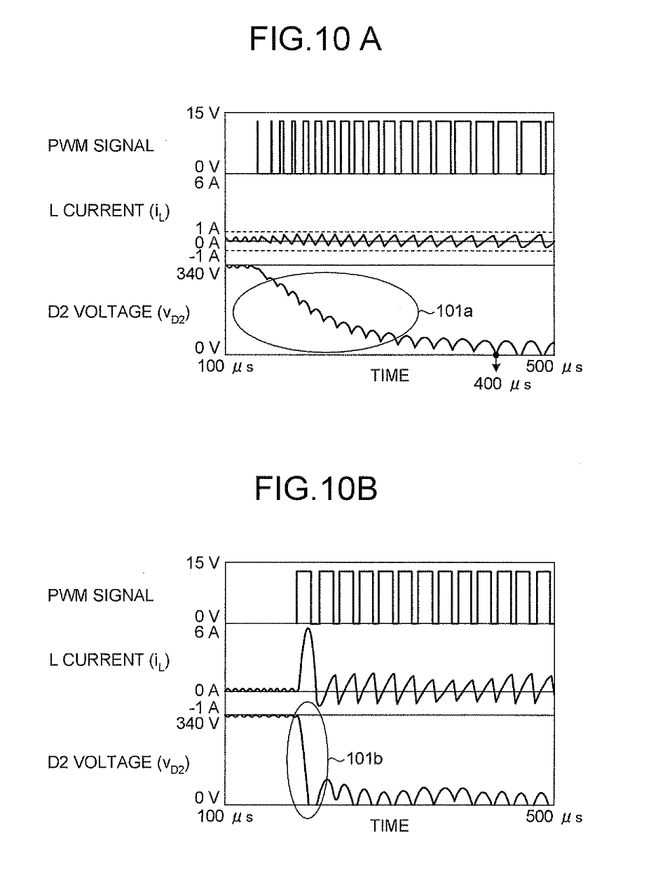

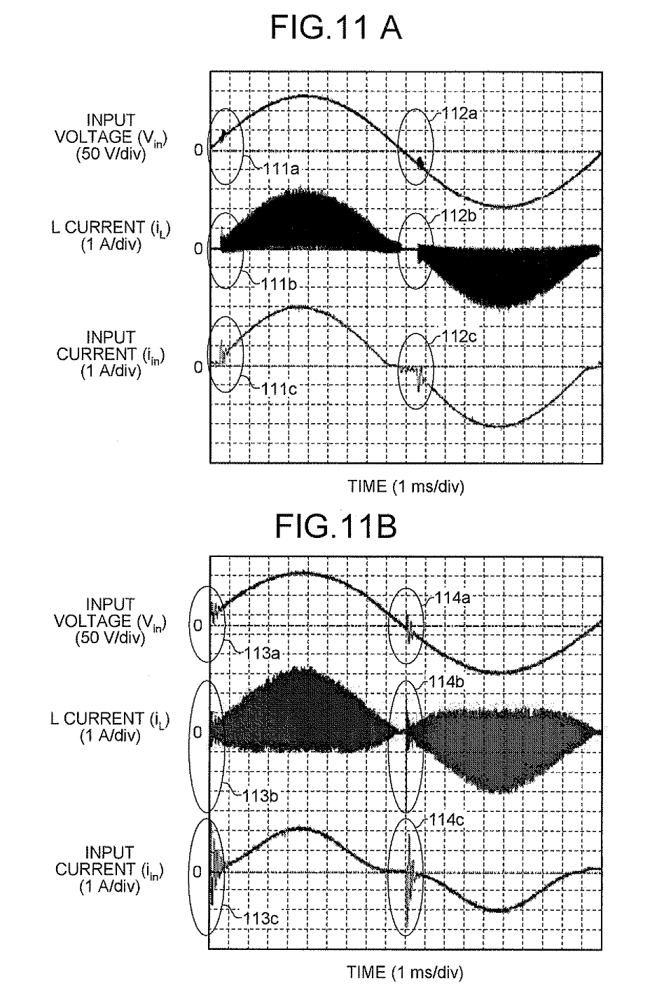

Regarding the operation waveform of the bridgeless power factor correction converter 10 based on the measured values, the case in which the soft start control is performed and the case in which the soft start control is not performed will be described using FIGS. 10A, 10B, 11A, and 11B. FIGS. 10A and 10B illustrate a first pattern of the operation waveforms when the soft start control is performed and the operation waveforms when the soft start control is not performed. FIGS. 11A and 11B illustrate similarly showing a second pattern of the operation waveforms.

FIG. 10A shows waveforms of a PWM signal, an inductor L current (i_{L}), and a diode D2 voltage (v_{D2}). As shown in FIG. 10A, when the soft start control is performed, the pulse width of the PWM signal is controlled so as to be gradually increased.

As a result, the variation of the inductor L current (i_{L}) is inhibited within a range of 1 A to −1 A. The diode D2 voltage (v_{D2}) gradually decreases from 340 V of the output voltage (Vₒᵤₜ) (see 101a in FIG. 10A) and reaches 0 at 400 μs.

In contrast, when the soft start control is not performed, as shown in FIG. 10B, the pulse width of the PWM signal is originally large in the start period; therefore, the inductor L current (i_{L}) has a maximum deflection width of 6 A.

The resonance phenomenon between the inductor L and the parasitic capacitor continues with a deflection width larger than that in FIG. 10A. Because the charge stored in the parasitic capacitor of the diode D2 is released all at once, the diode D2 voltage (v_{D2}) suddenly decreases (see 101b in FIG. 10B).

As described above, it is confirmed that a surge current is inhibited by performing the soft start control. FIGS. 10A and 10B illustrate the diode D2 voltage (v_{D2}) corresponding to the case where the input voltage polarity is negative. The diode D1 voltage (v_{D1}) corresponding to the case where the input voltage polarity is positive is similar to the diode D2 voltage (v_{D2}).

FIG. 11A shows the waveforms of the input voltage (Vᵢₙ), the inductor L current (i_{L}), and the input current (iᵢₙ). As shown in FIG. 11A, when the soft start control is performed, no significant distortion can be seen in the input voltage (Vᵢₙ), the inductor L current (i_{L}), and the input current (iᵢₙ) immediately after the zero cross point at which the polarity of the input voltage (Vᵢₙ) is switched from negative to positive (see 111a, 111b, and 111c in FIG. 11A).

Something similar occurs immediately after the zero cross point at which the polarity of the input voltage (Vᵢₙ) is switched from positive to negative (see 112a, 112b, and 112c in FIG. 11A). In the case shown in FIG. 11A, little distortion can be seen but reduction can be made for the distortion by making the adjustment in FIGS. 7A to 7C.

In contrast, when the soft start control is not performed, a significant distortion is seen in each of the waveforms of the input voltage (Vᵢₙ), the inductor L current (i_{L}), and the input current (iᵢₙ) immediately after each zero cross point as shown in FIG. 11B (see 113a, 113b, 113c, 114a, 114b, and 114c in FIG. 11B).

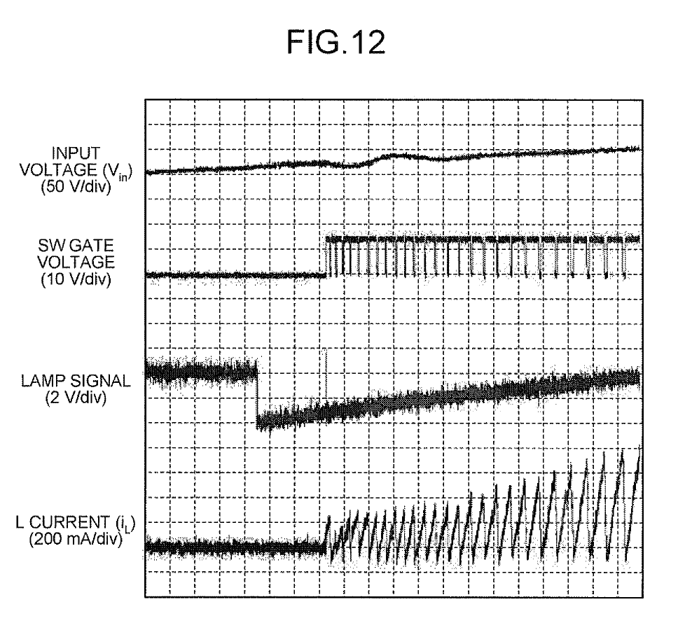

Detailed operation waveforms of the bridgeless power factor correction converter 10 when the soft start control is performed will be described using FIG. 12. FIG. 12 is a diagram of detailed operation waveforms when the soft start control is performed.

FIG. 12 shows the input voltage (Vᵢₙ), a SW gate voltage, a lamp signal, and the inductor L current (i_{L}). The lamp signal represents the reference voltage of the soft start control.

As shown in FIG. 12, immediately after the rise of the SW gate voltage, no surge current and no surge voltage can be seen in the inductor L current (i_{L}) and the input voltage (Vᵢₙ) and the effect of a surge inhibition by the soft start control is demonstrated.

As described above, in the first embodiment, the bridgeless power factor correction converter is configured such that the gate driver controls the ON ratio of the booster converter switch so as to be gradually increased from 0, i.e., performs the soft start control, every time the voltage polarity of an AC input in the totem-pole bridgeless power factor converter (TPBL converter is inverted) is inverted.

As described above, in the first embodiment, a surge can be prevented near the zero cross point of an AC input and thus noise reduction and efficiency improvement can be performed in the totem-pole bridgeless power factor converter (TPBL converter). In other words, this significantly contributes to the practical use of totem-pole bridgeless power factor converters (TPBL converters).

In the first embodiment, the most simple configuration of the totem-pole bridgeless power factor converters (TPBL converters) is described as an example. However, the circuit to which the gate driving method disclosed herein is applied is not limited to the circuit illustrated in the first embodiment. Another example of the circuit to which the gate driving method is applied will be described below as the second embodiment.

### Second Embodiment

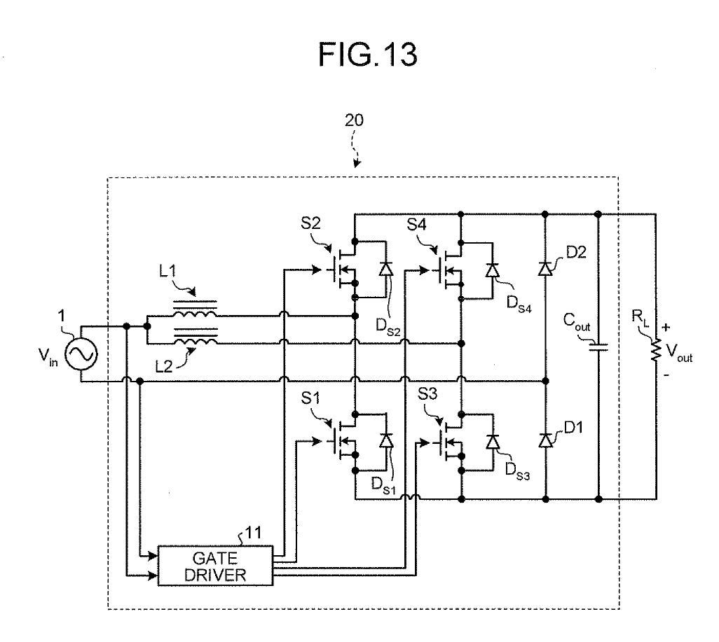

FIG. 13 is a diagram of a circuit configuration of a bridgeless power factor correction converter according to the second embodiment. FIG. 13 shows a bridgeless power factor correction converter 20, known as an interleaved converter, including parallel two booster converters each consisting of the inductor L, the switching device S1, and the switching device S2.

The same components in FIG. 13 as those in FIG. 2 are denoted by the same reference numbers as those in FIG. 2. The redundant descriptions of the components denoted by the same reference numbers as those in FIG. 2 will be omitted below.

As shown in FIG. 13, the bridgeless power factor correction converter 20 includes a booster converter consisting of the inductor L1, the switching device S1, and the switching device S2; and a booster converter consisting of an inductor L2, a switching device 53, and a switching device S4. FIG. 13 shows a body diode D_{S3} of the switching device S3 and a body diode D_{S4} of the switching device S4.

The two booster converters are provided in parallel and the gate driver 11 controls the phases of the switching cycles of the booster converters so as to be shifted by 180 degrees each. Except for the shifted phases, the gate driver 11 performs the soft start control on the switching devices included in each booster converter as is performed in the case of the first embodiment.

As described above, the gate driving method can be applied to the interleaved bridgeless power factor correction converter 20.

In each of the above-described embodiments, the case is described in which the present gate driving method is applied to the power factor correction converter that includes the diode D1 and the diode D2 as one-direction devices. Alternatively, the present gate driving method may be applied to a circuit that uses, instead of diodes, synchronous rectifier switches (for example, MOSFETs) that switch the gate between on and off in accordance with the polarity of the input voltage.

The present invention achieves an effect of noise reduction and efficiency improvement of a bridgeless power factor correction converter that has no bridge circuit that rectifies an AC input.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A bridgeless power factor correction converter, having no bridge rectifier circuit that rectifies an alternating current input from an alternating current power supply, the bridgeless power factor correction converter comprising:
a switching device for a booster converter; and
a gate driver that gradually increases an ON ratio of the switching device every time a voltage polarity of the alternating current input is inverted.

2. The bridgeless power factor correction converter according to claim 1 wherein the gate driver drives the switching device such that a value obtained by dividing a period in which the ON ratio is gradually increased by a period in which the voltage, polarity is constant is equal to or less than a predetermined value.

3. The bridgeless power factor correction converter according to claim 1, further comprising an inductor that has a first terminal connected to one terminal of the alternating current power supply, wherein
the switching device includes
a first switching device that has a first terminal connected to a second terminal of the inductor, and
a second switching device that has a first terminal connected to the second terminal of the inductor,
the bridgeless power factor correction converter further comprises
a first one-direction device that has an anode connected to a second terminal of the first switching device and has a cathode connected to another terminal of the alternating current power supply, and
a second one-direction device that has a cathode connected to a second terminal of the second switching device and has an anode connected to the other terminal of the alternating current power supply,
when the one terminal of the alternating current power supply has a positive voltage polarity, the gate driver causes the first switching device to be switched and keeps the second switching device off, and
when the other terminal of the alternating current power supply has a positive voltage polarity, the gate driver causes the second switching device to be switched and keeps the first switching device off.
